(19) United States
(12) Patent Application Publication
(10) Pub. No.: US 2026/0306971 A1
(43) Pub. Date: Oct. 8, 2026

(54) HYDRODYNAMIC SEPARATOR WITH MULTIPLE SETTLING SUMP CONES

(71) Applicant: Advanced Drainage Systems, Inc., Hilliard, OH (US)

(72) Inventors: Bo LIU, Clarksburg, MD (US); Erik HARTWELL, Mount Airy, MD (US); Gordon BAUGH, Columbus, OH (US); Christopher STONEBURG, Columbus, OH (US); Robin Maliszewskyj, Middletown, MD (US)

(73) Assignee: Advanced Drainage Systems, Inc., Hilliard, OH (US)

(21) Appl. No.: 19/715,220

(22) Filed: Jun. 22, 2026

Related U.S. Application Data
(63) Continuation of application No. 19/193,923, filed on Apr. 29, 2025.
(60) Provisional application No. 63/639,864, filed on Apr. 29, 2024.

(51) Int. Cl. B01D 21/00; B01D 21/02; B01D 21/24; E03F 5/14

(52) U.S. Cl. CPC B01D 21/0039; B01D 21/02; B01D 21/2444; E03F 5/14

(57) ABSTRACT

A separator for removing contaminants from a flow of wastewater is provided. The separator may include a tubular body, wherein the tubular body may include an inlet chamber and a sump chamber separated by an upper cone, a vertical cylinder extending from the inlet chamber to the sump chamber, and at least one lower cone in the sump chamber.

### CROSS-REFERENCE TO RELATED APPLICATIONS

This application claims the benefit of priority of U.S. Provisional Application No. 63/639,864 filed on Apr. 29, 2024, the contents of which are incorporated herein by reference in their entirety.

### TECHNICAL FIELD

This disclosure relates generally to systems, methods, and apparatuses for removing sediment and suspended solids from a flow of stormwater, and more particularly, to removing sediment and suspended solids from a flow of stormwater through use of a hydrodynamic separator.

### BACKGROUND

Stormwater management systems may be used to divert a flow of stormwater, such as runoff from rainfall events, from impervious surfaces and buildings. Stormwater management systems may, for example, include stormwater chambers in which sediment, debris, pollutants, or particulates may be removed from stormwater. As such, stormwater chambers may be provided underground to capture stormwater and to separate and retain particulates until they are deposited in the ground or in an off-site location.

Stormwater management systems may also use hydrodynamic separators to remove suspended solids, sediment, and other contaminants from stormwater. A hydrodynamic separator may be installed as part of a stormwater management system to remove particulates from the flow of stormwater before the stormwater enters a stormwater management chamber. Improvements to hydrodynamic separators are needed to increase the amount of particulate matter that may be separated from the flow of stormwater. Such improved hydrodynamic separators may neutralize velocities of the flow of stormwater to allow more particulate matter to separate from the flow of the stormwater within a sump chamber of the hydrodynamic separator. Such improved hydrodynamic separators may also mitigate the risk of resuspended sediment short circuiting to the outlet of the separator under high flow conditions.

### SUMMARY

The disclosed embodiments describe systems, methods, and devices for removing sediment and suspended solids from a flow of stormwater. These systems, methods, and devices may include a separator for removing contaminants from a flow of wastewater. The separator may include a tubular body, the tubular body comprising an inlet chamber and a sump chamber. The separator may further include an upper cone separating the inlet chamber from the sump chamber, wherein the upper cone may comprise a first end and a second end, and wherein a diameter of the first end may be greater than a diameter of the second end, and the upper cone may be oriented in the tubular body with the first end above the second end. The separator may further include a vertical cylinder extending from the inlet chamber to the sump chamber. The separator may further include at least one lower cone located in the sump chamber, wherein each of the at least one lower cones may comprise a first end and a second end, wherein a diameter of the first end may be greater than a diameter of the second end and each of the at least one lower cones may be oriented in the tubular body with the second end above the first end.

According to a disclosed embodiment, the tubular body may further comprise an inlet and an outlet.

According to a disclosed embodiment, the inlet chamber may be configured to contain the flow of stormwater entering the tubular body from the inlet.

According to a disclosed embodiment, the first end of the upper cone may contact an inner wall of the tubular body.

According to a disclosed embodiment, the second end of the upper cone may be connected to the vertical cylinder.

According to a disclosed embodiment, the upper cone may further comprise a weir box at the first end, wherein the weir box may be configured to prevent the flow of stormwater in the inlet chamber from exiting the inlet chamber through an outlet in the tubular body.

According to a disclosed embodiment, the vertical cylinder may comprise an inlet port and at least one window.

According to a disclosed embodiment, the inlet port may comprise an opening in the vertical cylinder located above the upper cone.

According to a disclosed embodiment, the at least one window may comprise an opening in the vertical cylinder located below the upper cone.

According to a disclosed embodiment, the vertical cylinder may comprise a corrugated-walled tubular body.

According to a disclosed embodiment, the at least one lower cone may comprise four lower cones.

According to a disclosed embodiment, the second end of each of the at least one lower cone may be connected to the vertical cylinder.

Embodiments of the present disclosure may further include a separator for removing contaminants from a flow of wastewater. According to a disclosed embodiment, the separator may include a tubular body, the tubular body comprising an inlet chamber and a sump chamber, a truncated cone separating the inlet chamber from the sump chamber, a vertical cylinder extending from the inlet chamber to the sump chamber, and at least one inverted truncated cone located in the sump chamber

According to a disclosed embodiment, the truncated cone may be attached to the vertical cylinder.

According to a disclosed embodiment, the at least one inverted truncated cone may be attached to the vertical cylinder.

According to a disclosed embodiment, the at least one inverted truncated cone may be located below the truncated cone in the tubular body.

According to a disclosed embodiment, each of the at least one inverted truncated cone may be stacked vertically along vertical cylinder.

According to a disclosed embodiment, the truncated cone may comprise at least one drain port.

According to a disclosed embodiment, each of the at least one inverted truncated cone may comprise at least one drain port.

According to a disclosed embodiment, the truncated cone and the at least one inverted truncated cone may be polygonal in shape.

### BRIEF DESCRIPTION OF THE DRAWINGS

The accompanying drawings constitute a part of this specification. The drawings illustrate several embodiments of the present disclosure, and together with the description, serve to explain the principles of the disclosed embodiments.

FIG. 1 depicts a separator with a plurality of inverted lower cones, according to disclosed embodiments.

FIG. 2A depicts a separator with a plurality of inverted lower cones, according to disclosed embodiments.

FIG. 2B depicts drain ports and an inlet port of a separator with a plurality of inverted lower cones, according to disclosed embodiments.

FIG. 2C depicts a top view of a separator, according to disclosed embodiments.

FIG. 3 depicts a section cut of a separator with a plurality of inverted lower cones, according to disclosed embodiments.

FIG. 4 depicts a separator with one inverted lower cone, according to disclosed embodiments.

FIG. 5 depicts a separator with one inverted lower cone, according to disclosed embodiments.

FIG. 6 depicts a separator with a polygonal upper cone and a plurality of polygonal lower cones, according to disclosed embodiments.

### DETAILED DESCRIPTION

Examples of embodiments of the present disclosure are described with reference to the accompanying drawings. In the figures, which are not necessarily drawn to scale, wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items or meant to be limited to only the listed item or items. It should also be noted that as used in the present disclosure and in the appended claims, the singular forms “a,” “an,” and “the” include plural references unless the context clearly dictates otherwise.

The disclosed embodiments improve deficiencies in existing hydrodynamic separators by providing a separator with an upper cone and a plurality of inverted lower cones located in the sump chamber of the separator. The plurality of inverted lower cones of the disclosed embodiments may increase the surface area of the cones within the sump chamber of the separator which may improve settling of particulate matter from the flow of stormwater. Additionally, the disclosed embodiments may neutralize the velocity of the flow of stormwater entering the sump chamber of the separator which may improve the settling of particulate matter from the flow of stormwater. The disclosed embodiments may further mitigate the risk of resuspended sediment short circuiting to the outlet under high flow conditions.

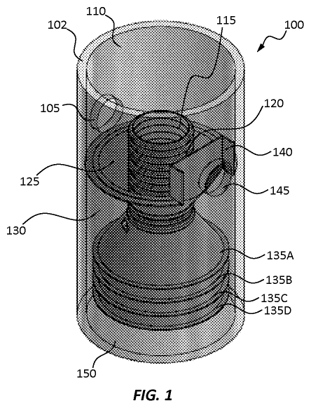

FIG. 1 depicts a separator 100 according to disclosed embodiments. Separator 100 may include a tubular body 102 which may enclose the flow of stormwater within separator 100. In some embodiments, a diameter of tubular body 102 may range from 3 feet to 12 feet. In other embodiments, the diameter of tubular body 102 may be less than 3 feet or greater than 12 feet. In some embodiments, a height of tubular body 102 may be greater than 4 feet. In other embodiments, the height of tubular body 102 may be 4 feet or less. Tubular body 102 may extend upwardly from base 150 and may comprise inlet 105 and outlet 145. Inlet 105 may comprise an opening in the wall of tubular body 102 that may allow a flow of stormwater to enter separator 100. In some embodiments, as depicted in FIG. 1, tubular body 102 may comprise one inlet 105. In other embodiments, tubular body 102 may comprise a plurality of inlets 105 which may be spaced apart from one another around the circumference of tubular body 102. The plurality of inlets 105 may be spaced equidistantly apart in some embodiments. In other embodiments, the distances between adjacent inlets 105 may vary. In such an embodiment, the plurality of inlets may be at a similar height on tubular body 102 or may be at varying heights on tubular body 102. Outlet 145 may comprise an opening in the wall of tubular body 102 that may allow a flow of treated stormwater to exit the separator 100. In some embodiments, an inflow pipe may be installed through inlet 105 to direct a flow of stormwater into separator 100 from a source. In some embodiments, an outflow pipe may be installed through outlet 145 to direct a flow of treated stormwater from within separator 100 to other components in a stormwater management system. In some embodiments, inlet 105 and outlet 145 may include features that extend from an outward surface of tubular body 102. In such embodiments, an inflow pipe and/or an outflow pipe may be connected to separator 100 by the surrounding or attaching to the features extending from the outward surface of tubular body 102.

Separator 100 may further include an inlet chamber 110 and a sump chamber 130 separated by an upper cone 125. Inlet chamber 110 may contain the flow of stormwater that enters separator 100 through inlet 105. The sump chamber 130 may receive the flow of stormwater and allow sediment and other particulates to settle out of the stormwater at the base 150 of separator 100, as disclosed herein. Upper cone 125 may separate inlet chamber 110 from sump chamber 130. Upper cone 125 may comprise a cone-shape with a first end and a second end. For example, in some embodiments, upper cone 125 may comprise a frustrum or a truncated cone. The walls of upper cone 125 may taper from the first end to the second end. In some embodiments, the first end and the second end of upper cone 125 may be circular in shape. The first end may comprise a larger diameter than the second end of upper cone 125. Upper cone 125 may be oriented in tubular body 102 such that the larger first end is located above the smaller second end. The larger first end of upper cone 125 may contact the inner walls of tubular body 102 to create a barrier between inlet chamber 110 and sump chamber 130. In some embodiments, the larger first end of upper cone 125 may contact the inner walls of tubular body 102 below inlet 105. A diameter of the larger first end of upper cone 125 may correspond to the diameter of tubular body 102. For example, in some embodiments, a diameter of the larger first end of upper cone 125 may range from 3 feet to 12 feet. In other embodiments, the diameter of the larger first end of upper cone 125 may be less than 3 feet or greater than 12 feet. Upper cone 125 may further comprise a weir box 140 located at the first end of upper cone 125. Weir box 140 may block outlet 145 to prevent stormwater in inlet chamber 110 from exiting separator 100 through outlet 145. For example, weir box 140 may extend upwardly from upper cone 125 and cover outlet 145 from inlet chamber 110. Weir box 140 may also provide an opening between upper cone 125 and the inner walls of tubular body 102 to allow the stormwater to exit sump chamber 130 through outlet 145.

Separator 100 may further include a vertical cylinder 115. Vertical cylinder 115 may extend through upper cone 125 and each of lower cones 135A-135D between inlet chamber 110 and sump chamber 130 and may facilitate the flow of stormwater from inlet chamber 110 to sump chamber 130. Vertical cylinder 115 may neutralize the velocity of the stormwater as it flows through vertical cylinder 115 to sump chamber 130 from inlet chamber 110. Vertical cylinder 115 may include an inlet port 120. Inlet port 120 may comprise an opening in vertical cylinder 115 that may allow the flow of stormwater to enter vertical cylinder 115 from inlet chamber 110 and flow downwardly to sump chamber 130. Upper cone 125 may be attached to vertical cylinder 115 at the smaller second end of upper cone 125. In some embodiments, as depicted in FIG. 1, vertical cylinder 115 may comprise a corrugated-walled tubular body. In other embodiments, vertical cylinder 115 may comprise a smooth-walled tubular body. In some embodiments, as depicted in FIG. 1, vertical cylinder 115 may comprise a circular cylinder. In other embodiments, vertical cylinder 115 may comprise a polygonal cylinder. For example, vertical cylinder 115 may be pentagonal, hexagonal, octagonal, or any other polygonal shape.

Separator 100 may further include a sump chamber 130 which may contain a flow of stormwater from inlet chamber 110 and may allow for sediment and other particulates to settle from the stormwater at base 150 of separator 100. Sump chamber 130 may include a plurality of lower cones 135A-135D. Each of lower cones 135A-135D may comprise a cone shape with first ends and second ends. For example, in some embodiments, each of lower cones 135A-135D may comprise an inverted frustrum or truncated cone. In some embodiments, the first ends and the second ends of lower cones 135A-135D may be circular in shape. The first ends may comprise a larger diameter than the second ends of the lower cones 135A-135D. The walls of each of lower cones 135A-135D may taper from the first end to the second end. For example, lower cones 135A-135D may be oriented in tubular body 120 such that the larger first ends are located below the smaller second ends. For example, lower cones 135A-135D may be oriented in an opposite direction of the orientation of upper cone 125. Lower cones 135A-135D may be attached to vertical cylinder 115 at the smaller second ends and stacked vertically along vertical cylinder 115 below upper cone 125. A distance between adjacent lower cones within the stacked lower cones 135A-135D along vertical cylinder 115 may vary depending on flow rates of the stormwater and the height of tubular body 102.

The flow of stormwater may exit vertical cylinder 115 within sump chamber 130 and flow through lower cones 135A-135D. Lower cones 135A-135D may reduce the velocity of the flow of stormwater which may increase the amount of particulates and sediment that may settle from the stormwater within sump chamber 130. The use of multiple lower cones 135A-135D may also provide more surface area within sump chamber 130 to facilitate settling of particulates and sediment from the stormwater. Lower cones 135A-135D may also mitigate the risk of resuspended sediment short-circuiting to outlet 145 under high flow conditions. The sediment and particulates may settle out of the stormwater within sump chamber 130 and accumulate at base 150 of tubular body 102. The flow of treated stormwater may then exit sump chamber 130 through outlet 145.

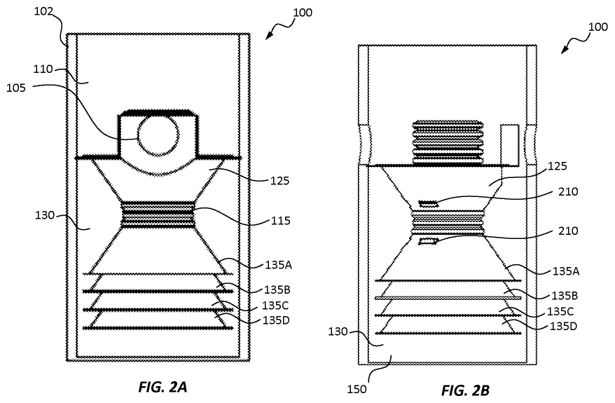

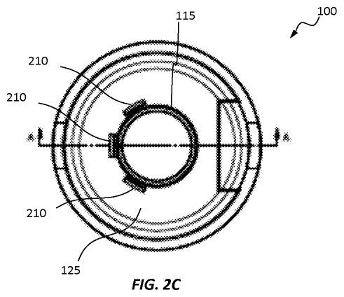

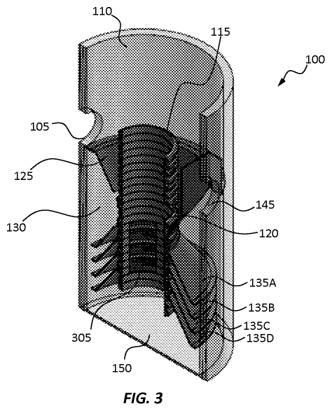

FIG. 2A depicts a side section view of separator 100. As depicted in FIG. 2A, upper cone 125 may be attached to vertical cylinder 115 at the smaller end of upper cone 125. Upper cone 125 may extend between the inner walls of tubular body 102 to separate inlet chamber 110 from sump chamber 130. Lower cones 135A-135D may also be attached to vertical cylinder 115 at the smaller ends of lower cones 135A-135D. Lower cones 135A-135D may be stacked vertically along vertical cylinder 115.

FIG. 2B depicts a side view of separator 100. As depicted in FIG. 2B, upper cone 125 and lower cone 135A may include drain port 210. Although not depicted in FIG. 2B, lower cones 135B-135D may also include drain ports similar to drain port 210. Drain port 210 may comprise an opening in the side of upper cone 125 and lower cones 135A-135D. Drain port 210 may allow for settled sediment to be washed to base 150 within sump chamber 130. FIG. 2C depicts a top view of separator 100. As depicted in FIG. 2C, upper cone 125 may include three drain ports 210. Although FIG. 2C depicts upper cone 125 with three drain ports 210, upper cone 125 may include more or fewer drain ports 210. Lower cones 135A-135D may also include more or fewer drain ports 210. Moreover, although FIG. 2C depicts drain ports 210 located on a second side of upper cone 125 and/or lower cones 135A-135D, drain ports 210 may be located on both the first side and second side of upper cone 125. In some embodiments, drain ports 210 may be spaced equidistantly apart from one another around the circumference of upper cone 125 and/or lower cones 135A-135D.

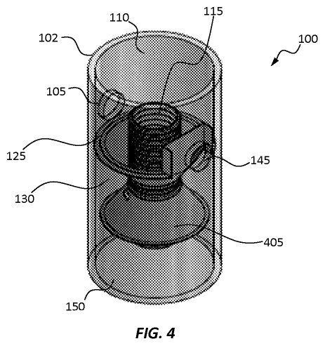

FIG. 3 depicts a section cut of separator 100. As depicted in FIG. 3, vertical cylinder 115 may extend through upper cone 125 and lower cones 135A-135D between inlet chamber 110 and sump chamber 130. Vertical cylinder 115 may comprise inlet port 120. Inlet port 120 may comprise an opening in vertical cylinder 115 that may be located above upper cone 125 in inlet chamber 110. Inlet port 120 may allow stormwater to enter vertical cylinder 115 from inlet chamber 110. Vertical cylinder 115 may further include at least one window 305. Window 305 may comprise an opening in vertical cylinder 115 that may be located below upper cone 125 in sump chamber 130. Window 305 may be configured to span one or more of lower cones 135A-135D. In some embodiments, as depicted in FIG. 3, window 305 may span all of lower cones 135A-135D. Although FIG. 3 depicts one window 305, vertical cylinder 115 may comprise more than one window 305. Window 305 may allow stormwater to exit vertical cylinder 115 and flow through lower cones 135A-135D. When the stormwater flows through lower cones 135A-135D, sediment and particulates may settle out of the stormwater and accumulate at base 150 of separator 100.

FIG. 4 depicts an embodiment of separator 100 with one lower cone 405. In such an embodiment, separator 100 may include a tubular body 102 including an inlet 105 and an outlet 145. Tubular body 102 may be separated into an inlet chamber 110 and a sump chamber 130 by upper cone 125. Vertical cylinder 115 may extend between inlet chamber 110 and sump chamber 130 and may facilitate a flow of stormwater from inlet chamber 110 to sump chamber 130. As depicted in FIG. 4, separator 100 may include one lower cone 405. Lower cone 405 may correspond to lower cones 135A-135D, as disclosed herein. Lower cone 405 may reduce the velocity of the flow of stormwater entering sump chamber 130. Reducing the velocity of the stormwater as it enters sump chamber 130 may improve the settling of particulates and sediments from the stormwater within sump chamber 130 and may also mitigate the risk of resuspended sediment short-circuiting to outlet 145 under high flow conditions. The sediment and particulates may settle out of the stormwater within sump chamber 130. The flow of treated stormwater may then exit sump chamber 130 through outlet 145. Although FIGS. 1-3 depict four lower cones 135A-135D and FIG. 4 depicts one lower cone 405, separator 100 may have any number of lower cones located within sump chamber 130.

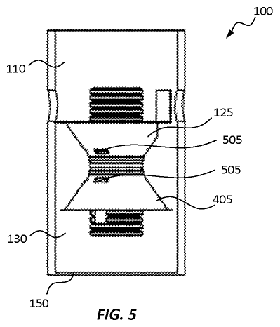

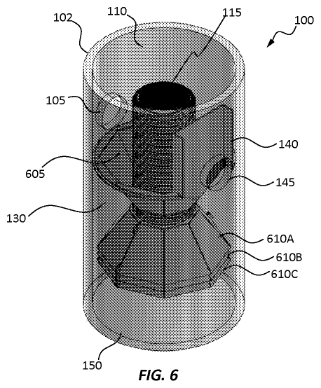

FIG. 5 depicts a side view of separator 100 with one lower cone 405. As depicted in FIG. 5, upper cone 125 and lower cone 405 may include drain port 505. Drain port 505 may correspond to drain ports 210, as disclosed herein with respect to FIG. 2B. Drain port 505 may comprise openings in the side of upper cone 125 and lower cone 405. Drain port 405 may allow for settled sediment to be washed to base 150 within sump chamber 130.

FIG. 6 depicts a separator 100 with a polygonal upper cone 605 and plurality of polygonal lower cones 610A-610C. Separator 100 may comprise tubular body 102 extending upwardly from base 150 with inlet 105 and outlet 145, as disclosed herein with respect to FIG. 1. Separator 100 may be divided into inlet chamber 110 and sump chamber 130 by polygonal upper cone 605. Polygonal upper cone 605 may correspond to upper cone 125, as disclosed herein with respect to FIG. 1. For example, polygonal upper cone 605 may comprise a first end and a second end, wherein a diameter of the first end is wider than a diameter of the second end. The first end of polygonal upper cone 605 may contact an inner wall of tubular body 102 to create a barrier between inlet chamber 110 and sump chamber 130. In some embodiments, polygonal upper cone 605 may contact the inner wall of tubular body 102 along the entire circumference of polygonal upper cone 605 such that the barrier formed between inlet chamber 110 and sump chamber 130 may be water tight. In other embodiments, the polygonal upper cone 605 may contact the inner wall of tubular body 102 along less than the entire circumference of polygonal upper cone 605. Polygonal upper cone 605 may further comprise weir box 140, which may block outlet 145 to prevent stormwater in inlet chamber 110 from exiting separator 100 through outlet 145. Polygonal upper cone 605 may be pentagonal, hexagonal, octagonal, or any other polygonal shape. Vertical cylinder 115 may extend between inlet chamber 110 and sump chamber 130 and may facilitate a flow of stormwater from inlet chamber 110 to sump chamber 130. Sump chamber 130 may include a plurality of polygonal lower cones 610A-610C. Polygonal lower cones 610A-610C may correspond to lower cones 135A-135D, as disclosed herein with respect to FIG. 1. For example, polygonal lower cones 610A-610C may reduce the velocity of the flow of stormwater which may increase the amount of particulates and sediment that may settle from the stormwater within sump chamber 130. Polygonal lower cones 610A-610C may be pentagonal, hexagonal, octagonal, or any other polygonal shape. Although FIG. 6 depicts three polygonal lower cones 610A-610C, sump chamber 130 may include more or fewer polygonal lower cones 610A-610C.

The foregoing description has been presented for purposes of illustration. It is not exhaustive and is not limited to precise forms or embodiments disclosed. Modifications and adaptations of the embodiments will be apparent from consideration of the specification and practice of the disclosed embodiments.

Moreover, while illustrative embodiments have been described herein, the scope includes any and all embodiments having equivalent elements, modifications, omissions, combinations (e.g., of aspects across various embodiments), adaptations and/or alterations based on the present disclosure. Other embodiments will be apparent from consideration of the specification and practice of the embodiments disclosed herein.

1-20. (canceled)

21. A separator for removing contaminants from a flow of stormwater, the separator comprising:
a tubular body, the tubular body comprising an inlet, an outlet, and a sump chamber;
a vertical cylinder extending into the sump chamber, the vertical cylinder having one or more windows; and
a plurality of baffles located in the sump chamber, wherein:
each of the plurality of baffles comprises a first end and a second end,
wherein a diameter of the first end is greater than a diameter of the second end; and
each of the plurality of baffles is oriented in the tubular body with the second end above the first end.

22. The separator of claim 21, wherein the vertical cylinder has a hexagonal shape.

23. The separator of claim 21, wherein the tubular body comprises a first opening at a top end of the tubular body and a second opening at a bottom end of the tubular body.

24. The separator of claim 21, further comprising an inflow pipe extending through the inlet and an outflow pipe extending through the outlet.

25. The separator of claim 21, wherein the tubular body extends upwardly from a base.

26. The separator of claim 23, further comprising a weir configured to prevent water from exiting the separator from the inlet directly through the outlet.

27. The separator of claim 21, wherein each of the plurality of baffles are affixed to the vertical cylinder.

28. The separator of claim 21, wherein each of the plurality of baffles are stacked vertically along the vertical cylinder.

29. The separator of claim 21, wherein a height of the tubular body is greater than 4 feet.

30. The separator of claim 21, wherein a diameter of the tubular body is between 3 feet and 12 feet.

31. The separator of claim 21, further comprising an inlet chamber.

32. The separator of claim 31, wherein the inlet chamber is configured to contain the flow of stormwater entering the separator.

33. The separator of claim 32, wherein the vertical cylinder extends between the sump chamber and the inlet chamber.

34. The separator of claim 21, wherein each of the plurality of baffles comprises a truncated cone.

35. The separator of claim 21, wherein the first end of each of the plurality of baffles is circular in shape.

36. The separator of claim 21, wherein a wall of each of the plurality of baffles tapers from the second end to the first end.

37. The separator of claim 21, wherein the flow of water is configured to exit the sump chamber through an outlet.

38. The separator of claim 21, wherein the one or more windows comprise openings in the vertical cylinder located in the sump chamber.

39. The separator of claim 21, wherein each of the plurality of baffles comprises a cone shape.

40. The separator of claim 21, wherein the plurality of baffles comprises at least four baffles.
